(19) United States
(12) Patent Application Publication
(10) Pub. No.: US 2025/0104033 A1
(43) Pub. Date: Mar. 27, 2025

(54) CONTENT CREATORS' REWARD SYSTEM AND METHOD

(71) Applicant: Maksim Kaimakov, Houston, TX (US)

(72) Inventor: Maksim Kaimakov, Houston, TX (US)

(21) Appl. No.: 18/372,065

(22) Filed: Sep. 23, 2023

(51) Int. Cl. G06Q 20/12; G06Q 20/14; G06V 40/16; G10L 25/63

(52) U.S. Cl. CPC G06Q 20/123; G06Q 20/145; G06V 40/174; G10L 25/63

(57) ABSTRACT

A system and method for enabling earning for a media content using facial expression recognition of a user is provided. The system comprises a user interface configured to present the media content to the user, a camera configured to capture a facial expression data of the user in response to the presented media content, and a processor coupled with the user interface and the camera. Further, the system comprises a memory coupled to the processor and comprising a computer readable program code embodied in the memory that configures the processor to receive the captured facial expression data from the camera, identify laughter or smile from the received facial expression data, and deduct a pre-set cost for the identified laughter or smile.

### FIELD OF THE DISCLOSURE

The present disclosure relates to a system and method for enabling earning for media content using facial expression recognition of a user.

### BACKGROUND

“Laughter is the best medicine” is a popular saying. While not scientifically proven, in a world full of stress, anxiety, and depression, laughter may be an effective short-term therapy to cope with these afflictions of modern life. Laughter draws people together in ways that trigger healthy physical and emotional changes in the body. Laughter strengthens the immune system, boosts mood, diminishes pain, and protects from the damaging effects of stress. The success of stand-up and live comedy and creation of comedy media content is testament to the value of humor.

Measuring the quality of comedic content is not possible because of its dependency on a user or a viewer. What is funny or entertaining is entirely in the eye of the beholder. For example, some users may find the content more humorous than others as it depends on the taste, nature, and humor of the individual viewer. Sometimes, media content is not even worth the time of the viewer. Still, the viewers must bear the same cost for the content in the form of subscription charges of a platform if the media content is streaming on online platforms or in the form of a club ticket in case of a live performance. More important, viewers pay for content whether they find it humorous or not. Therefore there is a need for a system and a method for the fairer compensation arrangements for content creators based on reactions in response to the media content.

### SUMMARY

This summary is provided to introduce a selection of concepts in a simplified form that are further disclosed in the detailed description of the disclosure. This summary is not intended to identify key or essential inventive concepts of the claimed subject matter, nor is it intended as a guide for determining the scope of the claimed subject matter.

The present disclosure discloses content creators reward systems, methods, and computer program products for enabling earning for media content by content creators using facial expression recognition of users enjoying the content.

An aspect of the present disclosure provides a user device configured to recognize facial expressions of a user in response to display of media content on the user device. The user device or other component charges or deducts a pre-set cost or amount for each laugh or smile detected on the face of the user. The user device is provided with a user interface, a camera, processing circuitry comprising at least one processor, and memory. The user interface displays the media content. The camera captures a facial expression data of the user in response to the presented media content. The user interface, the camera, and the memory are coupled with the processing circuitry in the user device The memory stores computer-readable program code executing on the processing circuitry to receive the captured facial expression data from the camera, identify laughter or smile from the received facial expression data, and deduct an amount for the identified laughter or smile.

According to the present aspect, the system further comprises a platform comprising at least a server and a database. Further, the platform comprises an expression library with a plurality of reference facial expressions stored at least within the database and at least partially in the user device in some embodiments.

Further, the system enables at least one content creator to upload the media content on the platform and pre-set the cost or amount for each laughter or smile identified in response to the uploaded media content.

Further, the system enables the user to create an account on the platform and view the media content on the user device. The media content is provided to the system by the content creator. The user device captures the facial expression data of the user in response to the presented media content using the camera. The account may hold a deposited amount of funds of the user. The user may add to or top-up the amount in the account when necessary. The user device receives the captured facial expression data of the user from the camera, matches, with the assistance of the server in some embodiments, the facial expression data with the plurality of expressions of the expression library to identify the laughter or smile, and deducts the a cost for the identified laughter or smile from the associated account of the user. Further, the user device stores the captured facial expression data within the expression library of the database.

According to another aspect, the system may further comprise a microphone to capture sound data of the user in response to the presented media content. Further, the system may comprise one or more vibration and motion detection sensors.

According to the present aspect, the user device may be further configured to receive the sound data from the microphone, detect a sound of laughter from the received sound data, detect vibration or motion concurrent to the detected sound of laughter, and identify the laughter based on the sound of laughter and the vibration or motion.

Further, the system provides for content creators to create accounts to receive the amounts paid by users for laughs as described above. The content creator may in embodiments be authorized to share content with a plurality of users or all users or to create a private zone for specific users.

Further, the system provides an open network of creators and marketplace for comedy content. The marketplace allows content creators to upload comedy content to the server. The marketplace allows users to select and enjoy comedy content from content creators who have provided content to the system. As noted, the user device monitors the facial expressions of the user, specifically to detect smiles or laughter in response to the comedy. Further, for each detected smile or laughter in response to the comedy content, the system deducts a certain amount from the user's account.

Various objects, features, aspects, and advantages of the inventive subject matter will become more apparent from the following detailed description of preferred embodiments, along with the accompanying drawing figures in which like numerals represent like components.

### BRIEF DESCRIPTION OF THE DRAWINGS

The embodiments of the disclosure itself, as well as a preferred mode of use, further objectives, and advantages thereof, will best be understood by reference to the following detailed description of an illustrative embodiment when read in conjunction with the accompanying drawings. One or more embodiments are now described, by way of example only, with reference to the accompanying drawings in which:

FIG. 1 depicts a network implementation of a system of pay per laugh using facial recognition according to an embodiment of the present disclosure.

FIG. 2 is a block diagram illustrating a system of pay per laugh using facial recognition according to an embodiment of the present disclosure.

FIG. 3 shows a view of the media content being presented to the user on a user device, according to one exemplary embodiment of the present disclosure.

FIG. 4 is a flowchart of a method of enabling earning for the media content using facial expression recognition of the user, according to an embodiment of the present disclosure.

The figures depict embodiments of the disclosure for purposes of illustration only. One skilled in the art will readily recognize from the following description that alternative embodiments of the structures and methods illustrated herein may be employed without departing from the principles of the disclosure described herein.

### DETAILED DESCRIPTION

In the following description, numerous specific details are set forth to provide a thorough understanding of the embodiments of the present disclosure. It will be apparent to one skilled in the art that embodiments of the present disclosure may be practiced without some of these specific details.

Embodiments of the present disclosure include various steps, which will be described below. The steps may be performed by hardware components or may be embodied in machine-executable instructions, which may be used to cause a general-purpose or special-purpose processor programmed with the instructions to perform the steps. Alternatively, steps may be performed by a combination of hardware and or by human operations.

Embodiments of the present disclosure for user devices and content creator's devices may be provided as a computer program product or a smartphone application. The program product or smartphone application may be stored in a machine-readable storage medium and when executed performs many of the functions described herein for each device. Other functionality described herein executes on the server and may be software stored in a machine-readable storage medium. Machine-readable media comprise fixed (hard) drives, magnetic tape, floppy diskettes, optical disks, compact disc, read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware).

Various methods described herein may be practiced by combining one or more machine-readable storage media containing the code according to the present disclosure with appropriate standard computer hardware to execute the code contained therein. An apparatus for practicing various embodiments of the present disclosure may involve one or more computers (or one or more processors within a single computer) and storage systems containing or having network access to a computer program(s) coded in accordance with various methods described herein, and the method steps of the disclosure could be accomplished by modules, routines, subroutines, or subparts of a computer program product.

If the specification states a component or feature “may”, “can”, “could”, or “might” be included or have a characteristic, that particular component or feature is not required to be included or have the characteristic.

As used in the description herein and throughout the claims that follow, the meaning of “a”, “an”, and “the” includes plural reference unless the context clearly dictates otherwise. Also, as used in the description herein, the meaning of “in” includes “on” unless the context clearly dictates otherwise.

Exemplary embodiments will now be described more fully hereinafter with reference to the accompanying drawings, in which exemplary embodiments are shown. This disclosure may, however, be embodied in many different forms and should not be construed as limited to the embodiments set forth herein. These embodiments are provided so that this disclosure will be thorough and complete and willfully convey the scope of the disclosure to those ordinary skills in the art. Moreover, all the statements herein reciting embodiments of the disclosure, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

While embodiments of the present disclosure have been illustrated and described, it will be clear that systems and methods provided herein are not limited to these embodiments only. Numerous modifications, changes, variations, substitutions, and equivalents will be apparent to those skilled in the art, without departing from the spirit and scope of the disclosure, as described in the claim.

Systems and methods described herein provide a content creators reward system that recognizes facial expressions, specifically laughter or smiles, in response to displayed media content, and deduct a cost for each detected laughter or smile. Systems and methods may also provide an open network marketplace for comedy content where a creator of content may share content and users may enjoy the content. Systems and methods may also evaluate the quality of content by monitoring the facial expressions of the user and require payment therefore.

Systems and methods described herein provide for pay-per-laugh using facial expression recognition. Systems, methods, and computer program products may enable providers of comic and entertainment content to earn compensation for each laugh or smile by users of systems provided herein.

Systems and methods include at least two ways of rewarding content creators. A content creators' reward system based on positive reactions (laughter and smiles) from content consumers (users) is provided. Users make a monetary deposit from which the payment for the service is deducted. The method of deduction and distribution of funds among creators may vary. Systems and methods for securing payment from users are not limited to those described above. In embodiments, instead of posting funds in advance to a payment account, users may provide debit or credit card account information that may be charged immediately upon securing services described herein. Alternatively, users may be billed later after they have received services and receive a monthly statement showing services received and payment due. They may make payment online, by mailing a check, by telephone payment, or other means as they may do with many other routine bills. In another embodiment, user funds in a deposit account may “freeze” or be held temporarily during a session in which a user is being shown material. In the event the user laughs or smiles, the frozen funds will be withdrawn from the account and sent to content creators. In the event the user does not laugh or smile, the frozen funds are “unfreezed” and returned back into the user's deposit account as payment is not to be made.

In one model, users pay a subscription fee for unrestricted access to content. A portion of the total subscription fees is directed to a content payment fund. The content payment fund is distributed among creators in proportion to the number of smiles elicited by their content. For example, the payout formula for creator (k) from the payment fund for a period (e.g., a month) could be as follows: creator payout (k)=payment_fund/total_smiles_on all content*smiles_on_creator_content (k). Other variations of the content creator payout formula are possible.

In another model that may be referred to as “Pay as you smile,” users make a deposit and only pay for content that makes them smile. A formula could be: creator_payout (k)=fixed_price*smiles_on_creator_content (k).

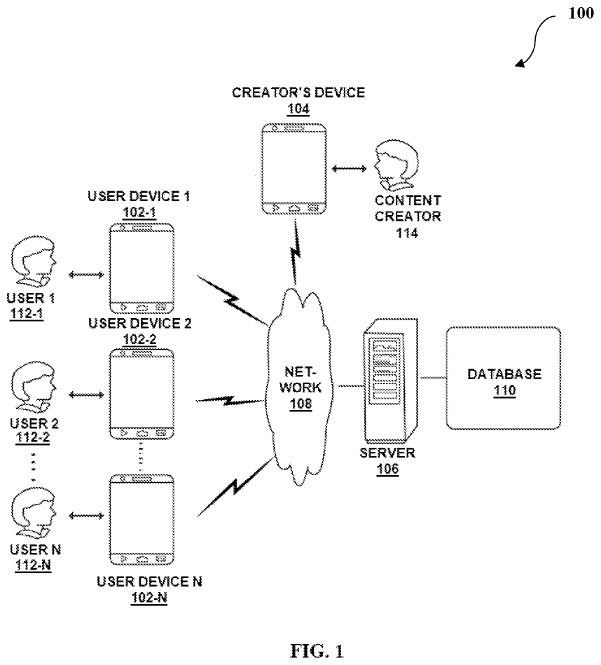

FIG. 1 depicts a network implementation of a system of pay per laugh using facial recognition according to an embodiment of the present disclosure. FIG. 1 illustrates components of a system 100 that enables earning of compensation by providers of media content displayed on user devices. The system 100 uses facial expression recognition of users 112 to recognize laughter by users 112 and may charge users 112 funds for each laugh and remit the funds to content creators or other provider(s) of the media content displayed to a particular user 112 that resulted in that user 112 laughing.

In an aspect, the system 100 comprises one or more user devices 102-1, 102-2 . . . 102-N (which are collectively referred to as user device 102, hereinafter) associated with the one or more users 112-1, 112-2 . . . 112-N (which are collectively referred to as users 112). The user devices 102 may be smartphones. Further, the system 100 comprises at least one content creator's device 104 associated with a content creator 114. The user device 102 and the content creator's device 114 may be communicatively coupled to the platform through a network 108. While the platform is not depicted in FIG. 1, the platform may comprise a server 106, a database 110, and associated components. The user device 102 may communicate with the server 106, the database 110 via the server 106, and the creator's device 104 via the network 108.

The content creator 114 may be any individual performance artist, group of artists, or an entity capable of creating a media content. Media content may comprise comedy content such as standup comedy, sketch comedy acts, improvisational comedy acts, or any other humorous performances. In embodiments, media content may not be humorous performances and may instead be other entertainment or creative material. The one or more users 112 may be any individual user or viewer of the media content via the user device 102. Further, the user device 102 and the creator's device 104 may be any one of a smartphone, a laptop computer, a desktop computer, a notebook, a workstation, a portable computer, a personal digital assistant, a handheld device and a mobile device.

The network 108 may be a wireless network, a wired network or a combination thereof. The network 108 can be implemented as one of the different types of networks, such as intranet, local area network (LAN), wide area network (WAN), the internet, Wi-Fi, LTE network, CDMA network, and the like. Further, the network 108 can either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further, the network 106 may include a variety of network devices, including routers, bridges, servers, computing devices, storage devices, and the like.

In an aspect, the creator's device 104 facilitates the content creator 114 to upload media content and set a cost for each laugh or smile. Similarly, the user device 102 facilitates the user 112 to view and/or listen to the media content uploaded by the content creator 114. The user device 102, using a locally installed camera, monitors the user's facial expression to collect facial expression data of the user 112 in response to the user viewing and/or listening to the media content. The facial expression data includes facial expressions such as anger, disgust, sadness, surprise, contempt, happiness, laughter, smile, or any other facial expression. The user device 102 further recognizes specifically laughter or smile and deducts the cost for each recognized laughter or smile as pre-set by the content creator 114 of the media content or pre-set by another party or component. Images of the user's face for use by the system at least in determining laughter and smiling may be stored locally on the user device 102, may be stored in the server 106, in the database 110, or in any combination of these components.

The platform further comprises a facial expression library stored within the database 110. The facial expression library (not shown in FIG. 1) comprises a plurality of facial expressions and variations of laughter or smiles. The user device 102 solely or in combination with the server 106 maps the collected facial expression data of the user with the plurality of facial expressions of the expression library to recognize the laughter or smile of the user. Further, the user device 102 solely or in combination with the server 106 stores the collected facial expression data within the expression library of the database 110 for use in future recognition. In embodiments, some portions of the expression library may be stored locally on the user device 102, on the server 106, or on another component.

The creator's device 104 stores the uploaded media content in the server 106, in the database 110, or elsewhere via the network 108. The platform comprising the server 106, the database 110, and associated components, facilitates access of the media content by users 112 over the user interface of the user device 102.

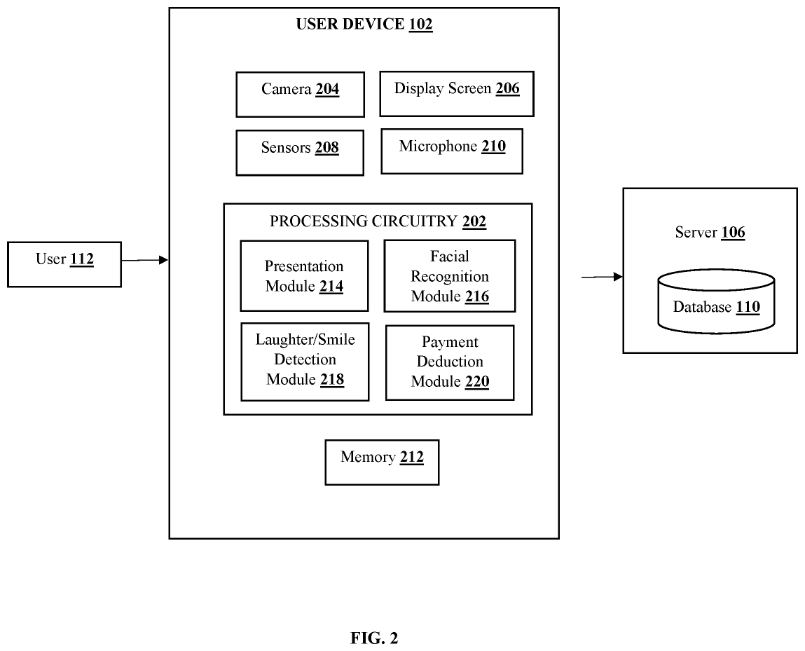

FIG. 2 is a block diagram showing a configuration of the system, according to an embodiment of the present disclosure.

Referring to FIG. 2, the user device 102 comprises processing circuitry 202, or at least one processor, and memory 212. The user device 102 also comprises a camera, 204, a display screen 206, one or more sensors 208, and a microphone 210 coupled to at least the processing circuitry 202. The one or more sensors 208 may include a vibration sensor and a motion detection sensor. The display screen 206 presents at least media content to the user 112. The camera 204 monitors and captures facial expression data in response to media content presented on the display 206. The sensors 208 monitor vibration and motion of the user 112 in response to presented media content. The microphone 210 is configured to capture voice data of the user 112.

The processing circuitry 202 also comprises a presentation module 214, a facial recognition module 216, a laughter/smile detection module 218, and a payment deduction module 220.

The processing circuitry 202 executes a computer-readable program code stored in the memory 212 and configures a user interface within the display screen 206 of user device 102. The server 106 may feature a user interface accessible via administrative devices (not shown in the figures) that are coupled with the network 106. The user interface of the server 106 is accessible via the network 108 to enable the content creators 114 to upload media content and authorize user devices 102 to access that media content. The platform comprising at least the server 106 and the database 110 may be configured within the display screen 206 of the user device 102 when the user of the user device 102 has appropriate permissions. The platform may be a dedicated platform or software application. The platform may also be a plug-in platform that may be configured or associated with various third-party media content streaming platforms.

According to an embodiment, the user device 102 and the creator's device 104 may comprise the same or similar components as they are conventional mobile devices, for example cellphones in many embodiments. An interface is provided by the server 106 to enable the creator's device to register and create an account associated with the content creator 110 on the platform. The creator's device 104, using its user interface, requests credentials of the content creator 110 to register and create an account on the platform. The credentials of the content creator 110 may include biometrics and other personal details such as name, email address, and other contact information.

In one embodiment, the processing circuitry of the creator's device 104 requests the content creator 110 to record the media content within the user interface of the creator's device 104, using the camera 204, or upload the existing media content from a storage of the content creator's device 104. The creator's device 104 transmits and stores media content created or uploaded by the content creator 110 over the platform, i.e., via the server 106, for the one or more users 112 to access and enjoy watching the media content.

The creator's device 104 may enable the content creator 110 to create a private zone for access by specific users 112. The creator's device 104 may enable the content creator 110 to receive requests from users 112 to join the private zone associated with the content creator 110.

Similarly, the processing circuitry 202 and other components of the user device 102 enable users 112 to register over the platform via the network 108 and access the media content. The server 106 may request user credentials from the user 108 and may configure a server-side user interface on the platform associated with the user 108 to substitute for or supplement the user interface provided locally on the user device 102. Further, the user device 102 creates an account associated with the user 112 to hold the balance of deposited funds on behalf of the user 108. The account may be locally stored on the user device 102, the account may be stored on the server 106 or other component accessible via the network 108, the account may be stored via a combination of local and network-based components, or the account may be stored and administered in another manner. The user 112 may be able to “top-up” or otherwise add to the balance of his/her account to watch and enjoy the media content.

Once registered with the platform comprising at least the server 106 and database 110, the user device 102 presents available media content on the display screen 206 of the user device 102 to enable the user 112 to select items of media content to watch. Simultaneously, the user device 102 activates the camera 204 to capture facial expressions of the user 112. The camera 204 collects the facial expression data of the user 112 in response to user reaction to the presented media content.

The user device 102 receives the collected facial expression data from the camera 204 to process and detect the laughter or smile of the user 112 in response to the presented media content. The user device 102 maps the collected facial expression data of the user 112 with the facial expressions library stored within the database 110 and with locally stored facial images in some embodiments. By mapping the facial expression data, the user device 102 recognizes smile or laughter of the user 112 in response to the media content. The user device 102 accesses the facial expressions library through the network 108.

In one aspect, the user device 102 may also use the one or more sensors 208 and the microphone 210 along with the camera 204 to recognize the smile or laughter of the user 112. For instance, the user device 102 may activate the microphone 210 and one or more sensors 208 including the vibration sensor and motion detection sensor along with the camera 204. The microphone 210 may capture sound data associated with the user 112 in response to the presented media content. The one or more sensors 208 may monitor the vibration and movement of the user 112 when the user 112 laughs.

In the present embodiment, the database 110 or other component may further comprise a sound library having a plurality of sounds of laughter. The user device 102 may receive the captured sound data from the microphone and map it across the network 108 with the sound library to identify the laughter and verify the laughter detected by the user device 102 using facial expression recognition.

The user device 102 may overlap the laughter recognized using facial expression recognition, sound recognition, and vibration or motion recognition to validate the detected laughter.

The user device 102 and/or the server 106 deducts a pre-set cost from the account associated with the user 112 for recognized laughter or smiles. Further, the user device 102 or the server 106 may retain the deducted cost until the content creator 110 requests for the payment or reaches to a threshold amount for auto-payment into an account associated with the content creator 110.

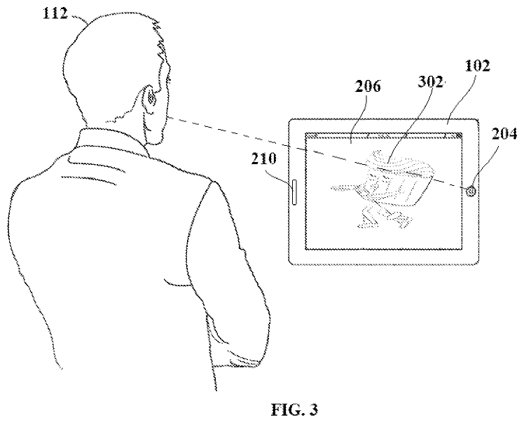

FIG. 3 provides a view of the media content 302 being presented to the user 112 on the user device 102, according to one exemplary embodiment of the present disclosure. The camera 204 and the microphone 210 continuously monitor facial expressions and sounds of the user 112 to recognize each laughter or smile of the user 112 in response to media content 302 that is being presented on the user interface 206 of the user device 102. It is to be noted that the terms “user interface” and “display screen 206” may be used interchangeably for easy understanding in the embodiment presented in FIG. 3.

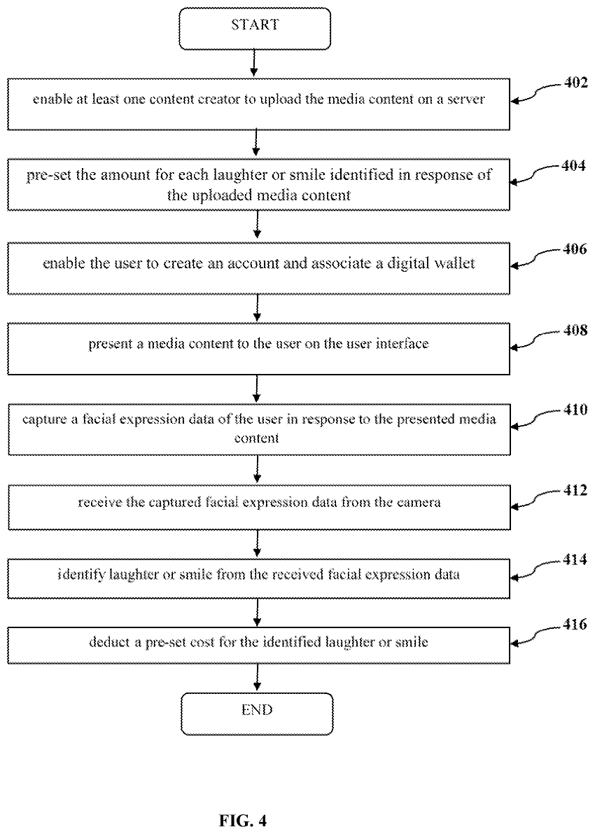

FIG. 4 is a flowchart 400 of a method of enabling earning for the media content 302 using facial expression recognition of the user 112, according to an embodiment of the present disclosure.

Referring to FIG. 4, the creator's device 104 enables at least one content creator 110 to upload media content 302 over the platform, at step 402. For example, the creator's device 104 may provide a user interface on the creator's device 104 to the content creator 110 to record or upload the media content 302 onto the platform for access by user devices 102.

Further, the creator's device 104 or other component requests the content creator 110 to pre-set the cost for each laughter or smile identified in response to the uploaded media content 302 by the content creator 110, at step 404. For example, once the media content 302 is uploaded, the creator's device 104 or other component requests the content creator 110 to select the cost i.e. $0.5 for each laughter and $0.25 for each smile.

Further, the user device 102 or other component enables the user 112 via the user device 102 to register over the platform using credentials and to create an account to hold a balance associated at step 406. For example, the user device 102 requests the user 112 to input the user credentials using the user device 102 to register over the platform. Further, the user device 102 creates an account to hold the balance of the user 112 that may be used by the user 112 to watch and/or listen to the media content 302.

Further, the user device 102 presents media content 302 to the user 112 on the user interface configured in the display screen 206 of the user device 102, at step 408. For example, the user device 102 configures the user interface with listings of all or many choices of media content 302 accessible via the platform from which the user 108 may make selections

Successively, the camera 204 captures the facial expressions data of the user in response to the presented media content 302, at step 410.

Further, the processing circuitry 202 receives the captured facial expression data from the camera 204, at step 412.

Successively, the processing circuitry 202 processes the captured facial expression data in real time to identify the laughter or smile from the received facial expression data, at step 414.

Finally, the processing circuitry 202 deducts the pre-set cost for the recognized laughter or smile of the user 112, at step 416.

According to one aspect, the systems described herein are provided as a marketplace for comedy content and a network of content creators and users. The marketplace includes a pool of comedy content created and uploaded by a plurality of content creators 114. Further, the marketplace includes a plurality of users to access the pool of content.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component.

The terms “an embodiment”, “embodiment”, “embodiments”, “the embodiment”, “the embodiments”, “one or more embodiments”, “some embodiments”, and “one embodiment” mean “one or more (but not all) embodiments of the disclosure(s)” unless expressly specified otherwise.

Similarly, structures and functionality presented as a single component may be implemented as separate components. These and other variations, modifications, additions, and improvements fall within the scope of the subject matter herein. In addition, the term “each” used in the specification does not imply that every or all elements in a group need to fit the description associated with the term “each”. For example, “each member is associated with element A” does not imply that all members are associated with an element A. Instead, the term “each” only implies that a member (of some of the members), in a singular form, is associated with an element A.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that are issued on an application based hereon. Accordingly, the disclosure of the embodiments is intended to be illustrative, but not limiting, of the scope of the patent rights.

What is claimed is:

1. A content creators reward system, comprising:
a user device comprising;
a user interface that presents media content,
a camera that captures facial expression data of a user of the device in response to the presented media content;
processing circuitry coupled with the user interface and the camera; and
memory coupled to the processing circuitry and storing computer readable program code that when executed on the processing circuitry:
presents the media content to the user on the user interface;
receives the captured facial expression data from the camera;
identifies laughter or smile from the received facial expression data; and
deducts a pre-set cost for the identified laughter or smile.

2. The system of claim 1, wherein alternatively the user periodically remits a subscription fee for unrestricted access to media content, a portion of the fee deposited to a content payment fund, and wherein amounts in the fund are distributed to media content creators associated with the fund in proportion to a number of smiles from all subscribers elicited by their content

3. The system of claim 1, wherein the system further comprises a platform coupled to the user device through a network, the platform comprising a at least a server and a database hosting an expressions library containing a plurality of stored facial expressions.

4. The system of claim 3, wherein the system is further configured to enable at least one content creator to:
upload the media content on the platform; and
pre-set the cost for each laughter or smile by users identified in response to the uploaded media content.

5. The system of claim 4, wherein the system is further configured to:
enable the user to register over the platform and create an account to hold a balance of the user,
present the media content on the user interface, the content uploaded by the content creator, and
capture the facial expression data of the user in response to the presented media content using the camera.

6. The system of claim 5, wherein the system is further configured to,
receive the captured facial expression data of the user;
map the facial expression data with the plurality of expressions of the expression library to identify the laughter or smile; and
deduct the pre-set cost for the identified laughter or smile from the associated account of the user.

7. The system of claim 1, wherein the system further stores the captured facial expression data in the expression library of the database.

8. The system of claim 1, wherein the user device further comprises a microphone to capture sound data of the user in response to the presented media content.

9. The system of claim 1, wherein the user device further comprises at least one of a vibration sensor and a motion detection sensor.

10. The system of claim 1, wherein the user device is further configured to:
receive sound data from the microphone,
detect a sound of laughter from the received sound data,
detect vibration or motion concurrent to the detected sound of laughter, and identify laughter based on the sound of laughter and the vibration or motion.

11. The system of claim 1, wherein the system is further configured to enable the content creator to share content with a plurality of users or to create a private zone for specific users.

12. The system of claim 1, wherein the user interface is a display screen of the user device.

13. The system of claim 12, wherein the user device is one of a network enabled computing device comprising at least one of a laptop computer, a desktop computer, a notebook, a workstation, a portable computer, a personal digital assistant, a handheld device, and a mobile device.

14. A method for enabling earning for a media content using facial expression recognition of a user of a user device, the method comprising:
presenting, by a user device, media content in a user interface of the device;
capturing, by a camera contained within the user device, a facial expression data of the user;
receiving, by processing circuitry in the user device, the facial expression data of the user captured by a camera;
identifying, by the processing circuitry, laughter or smile from the received facial expression data; and
deducting, by the processing circuitry, a pre-set cost for the identified laughter or smile.

15. The method of claim 14, further comprising:
a server enabling at least one content creator to upload media content to a database;
the server receiving media content sent by a creator's device;
the server storing the media content in the database;
the server administering deduction of a pre-set cost for each laughter or smile identified by a user device in response to the media content displayed by the user device.

16. The method of claim 15, further comprising the user device:
enabling the user to register with the server and create an account to hold a balance;
displaying the media content sent to the server by the content creator; and
capturing the facial expression data of the user in response to the media content using the camera.

17. The method of claim 17, wherein the user device is further configured to,
receive the captured facial expression data of the user;
map the facial expression data with a plurality of expressions of the expression library to identify the laughter or smile; and
deduct the pre-set cost for the identified laughter or smile from the associated account of the user.

18. The method of claim 14, wherein processing circuitry of the user device is configured to,
receive a sound data from a microphone;
detect a sound of laughter from the received sound data;
detect vibration or motion concurrent to the detected sound of laughter using a vibration and a motion sensors; and
identify the laughter based on the sound of laughter and the vibration or motion.

19. A computer program product for enabling earning for a media content using facial expression recognition of a viewer, comprising:
a non-transitory computer readable program code stored in a memory of a user device, that when executed on the device:
presents media content in a user interface of the device;
captures a facial expression data of viewer of the device by a camera executing on the device;
identifies laughter or smile from the facial expression data; and
deducts a pre-set cost for the identified laughter or smile.
